(19) United States
(12) Patent Application Publication
(10) Pub. No.: US 2012/0013643 A1
(43) Pub. Date: Jan. 19, 2012

(54) DISPLAY APPARATUS AND CONTROL METHOD THEREOF

(75) Inventor: Yong-ku KIM, Seoul (KR)

(73) Assignee: SAMSUNG ELECTRONICS CO., LTD., Suwon-si (KR)

(21) Appl. No.: 13/104,402

(22) Filed: May 10, 2011

(30) Foreign Application Priority Data
Jul. 13, 2010 (KR) 10-2010-0067293

(51) Int. Cl. G09G 5/00

(52) U.S. Cl. 345/634

(57) ABSTRACT

A display apparatus which displays an image and a control method thereof, the display apparatus including: a display unit; a storage unit which stores therein at least one of preset image pattern information of patterning contents of a plurality of images to retrieve such images and matching information related to the images matching each of the pattern information; a pattern receiver which receives predetermined information of a first pattern that is input from the outside; and an image processor which selects pattern information relating to the first pattern from the preset image pattern information and selects the first image matching the selected pattern information based on the matching information to display the image on the display unit, and selects the second image matching the first pattern by retrieving contents of the images from the plurality of images to display the image on the display unit.

### CROSS-REFERENCE TO RELATED APPLICATION

This application claims priority from Korean Patent Application No. 10-2010-0067293, filed on Jul. 13, 2010 in the Korean Intellectual Property Office, the disclosure of which is incorporated herein by reference in its entirety.

### BACKGROUND

1. Field

Apparatuses and methods consistent with the exemplary embodiments relate to a display apparatus which displays an image and a control method thereof, and more particularly, to a display apparatus and a control method thereof which retrieves and displays an image matching a predetermined pattern from an image database upon receiving an input of such pattern.

2. Description of the Related Art

A display apparatus includes various devices such as a TV, a computer monitor or a portable media player, and displays an image thereon based on image data that is input from the outside or stored therein. Recently, the display apparatus is equipped with various functions such as Web surfing by being connected to a network or executing various applications to meet user's needs in addition to displaying images.

The display apparatus may provide a retrieval function for an image registered in an image database. According to this retrieval function, each image has meta information that records relevant information as a text, and the image having the meta information including the text is selected and displayed upon a user's input of such text. However, such text-based retrieval is on the premise that meta information is added to the image instead of a content of an image itself. As a text, the meta information has its limitation on expressing the content of the image. For example, if information which is used for an image retrieval is an image not a text, a user need to figure out and input text description of such image. Since the user is describing the image, it may be hard to obtain a desired image retrieval result.

### SUMMARY

Accordingly, an image retrieval method that scans a content of an image registered in the image database and retrieves an image matching the content upon a user's input of a simple image has been proposed.

The foregoing and/or other aspects may be achieved by providing a display apparatus including: a display unit; a pattern receiver which receives a first pattern that is input from outside; and an image processor which performs a primary retrieval in which pattern information relating to the first pattern from the preset image pattern information which is patterning contents of a plurality of images to retrieve the images, is selected and the first image matching the selected pattern information based on the matching information is selected, and which performs a secondary retrieval in which a second image matching the first pattern is selected by retrieving contents of the images.

The image processor may update the preset image pattern information with the first pattern, and may update the matching information with a secondary retrieval result.

The display unit may display at least one of the image pattern information matching the displayed first image, together with the second image.

The image processor may cause the display unit to sequentially display the first image according to a number of the pattern information matching the first pattern if the pattern information selected from the preset image pattern information is plural.

The image processor may select and cause the display unit to display the first image based on the matching information and may omit a retrieval of entire images if it is determined that the first pattern is substantially the same as one of the preset image pattern information.

The display apparatus may further include a user input unit which receives input of the first pattern and transmits the input first pattern to the pattern receiver.

The user input unit may include at least one of a touch pad, a touch screen, and a tablet.

The preset image pattern information may include a two-dimensional diagram formed by at least one dot and at least one line.

The plurality of images may be stored in the storage unit or in a server that is connected to the display apparatus by a local connection or a network.

The foregoing and/or other aspects may be achieved by providing a method of controlling a display apparatus, the method including: receiving a first pattern which is input from outside; selecting pattern information related to the first pattern from preset image pattern information which is patterning contents of a plurality of images to retrieve the images and selecting and displaying a first image matching the selected pattern information based on matching information; and selecting and displaying a second image matching the first pattern by retrieving the contents of the images.

The displaying the second image may include updating the preset image pattern information with the first pattern, and updating the matching information with a retrieval result of the second image.

The displaying the first image and displaying the second image may include displaying the at least one of the image pattern information matching the first image, together with the second image.

The displaying the first image may include sequentially displaying the first images according to a number of pattern information matching the first image if the pattern information selected from the preset image pattern information is plural.

The control method may further include selecting and displaying the first image based on the matching information and omitting a retrieval of the plurality of images if it is determined that the first pattern is substantially the same as one of the preset image pattern information.

According to another aspect, a non-transitory computer readable medium storing instructions is provided. The instructions include receiving a first pattern, selecting at least one second pattern that relates to the first pattern from a number of second patterns that pattern contents of images, selecting at least one first image that matches the at least one selected second pattern based on matching rules for matching the images to the respective at least one second pattern, and selecting at least one second image by directly comparing the plurality of images with the first pattern.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a display apparatus according to an exemplary embodiment;

FIGS. 2A-2D are views illustrating exemplary image pattern information which is used for retrieving an image by the display apparatus according to an exemplary embodiment;

FIG. 3 is a view illustrating an image retrieval result which is displayed first with respect to a predetermined input pattern from the display apparatus according to an exemplary embodiment;

FIG. 4 is a view illustrating an image retrieval result which is displayed second with respect to the image retrieval result according to an exemplary embodiment;

FIG. 5 is a view illustrating a displayed image retrieval result when pattern information which is substantially the same as a predetermined input pattern exists among preset image pattern information in the display apparatus according to an exemplary embodiment;

FIG. 6 is a control flowchart illustrating a process of retrieving an image by inputting a predetermined pattern in the display apparatus according to an exemplary embodiment; and

FIG. 7 is a block diagram illustrating a display apparatus according to another exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to analogous elements throughout. Exemplary embodiments will be described regarding elements that directly relate to an inventive concept, and descriptions of other elements will be omitted. However, it does not mean that the elements whose descriptions are omitted are unnecessary for embodying a display apparatus.

The display apparatus 1 according to an exemplary embodiment includes a TV, but not limited thereto. Alternatively, the display apparatus 1 may further include a computer monitor, a portable media player, a mobile phone, and an electronic frame, and so on.

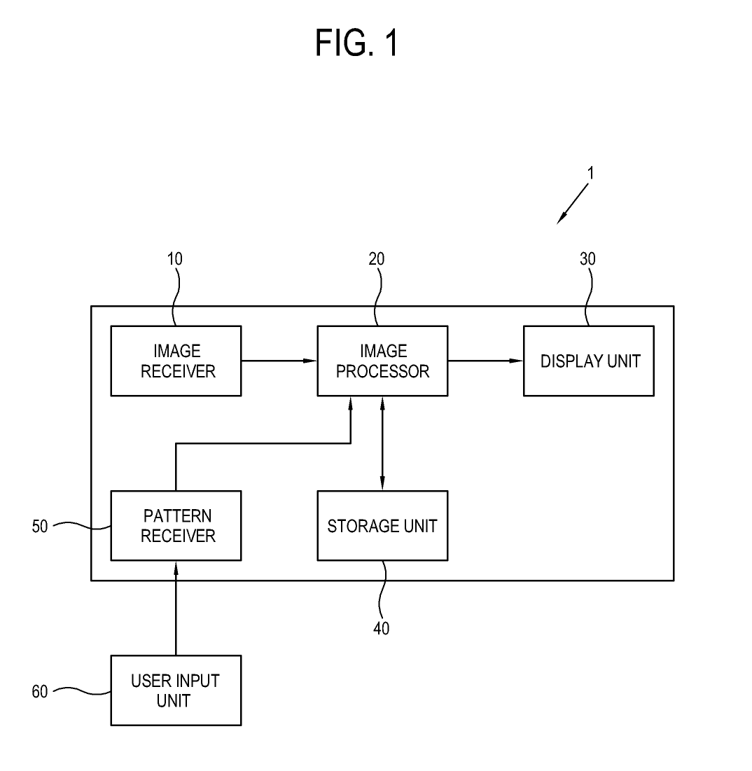

FIG. 1 is a block diagram illustrating a display apparatus 1 according to an exemplary embodiment.

As shown therein, the display apparatus 1 includes an image receiver 10 which receives an image signal from the outside, an image processor 20 which processes an image signal received by the image receiver 10, a display unit 30 which displays thereon an image based on the image signal processed by the image processor 20, a storage unit 40 which stores therein various data and information processed by the image processor 20, and a pattern receiver 50 which receives predetermined pattern information that is input from the outside.

The image receiver 10 receives an image signal and transmits such image signal to the image processor 20. The image receiver 10 may vary depending on standards of received image signals and the type of the display apparatus 1.

For example, if the display apparatus 1 includes a TV, the image receiver 10 may receive a radio frequency (RF) signal from a broadcasting station (not shown) in a wireless manner or receive an image signal in a wired manner according to standards such as composite video, component video, super video, SCART or High Definition Multimedia Interface (HDMI). If an image signal includes a broadcasting signal, the image receiver 10 includes a tuner which tunes such broadcasting signal by channel.

The image processor 20 processes an image signal in various preset methods. The image processor 20 processes the image signal and outputs such image signal to the display unit 30 to thereby display such image on a display area of the display unit 30.

The image processing performed by the image processor 20 may vary. For example, the image processor 20 may decode/encode image signals corresponding to various image formats, or deinterlace, convert frame refresh rate, scale, reduce noise, or detail-enhance image signals. The image processor 20 may include elements to individually perform the foregoing processes or include an integrated element integrating the foregoing functions.

Upon receiving predetermined pattern information through the pattern receiver 50, the image processor 20 may retrieve an image matching such pattern information from an image database and display a retrieval result on the display unit 30. The configuration of the image processor 20 will be described later.

The display unit 30 displays thereon an image processed by the image processor 20. The display apparatus 30 may vary including, without limitation to, a liquid crystal display (LCD) panel, a plasma display panel (PDP), a light emitting diode (LED) panel, an organic light emitting diode (OLED) panel, a surface-conduction electron-emitter panel, a carbon nano-tube panel, or a nano crystal panel.

The storage unit 40 may include a non-volatile memory such as a hard disc drive (HDD), a solid state drive (SSD), a flash memory, etc. and store various data therein. The storage unit 40 is provided for the image processor 20 to access the stored data.

The storage unit 40 stores therein an image database in which a plurality of images are registered, at least one of preset image pattern information of patterning a content of images to retrieve such images, and matching information matching each image of the image database per image pattern information. The image pattern information and the matching information will be described later.

The pattern receiver 50 receives predetermined pattern information from the outside and transmits such pattern information to the image processor 20. The pattern receiver 50 may receive the pattern information from the user input unit 60.

The user input unit 60 may include a touch pad, a touch screen or a tablet to input a predetermined pattern by having the user handwrite the input. Otherwise, the user input unit 60 may include a computer main body and a user may transmit predetermined pattern information to the pattern receiver 50 through such computer main body.

With the foregoing exemplary configuration, upon receiving predetermined pattern information through the pattern receiver 50, the image processor 20 may scan the contents of entire images stored in the image database and select an image matching the received pattern information from the image database. However, the above process requires scanning of all images to obtain the contents of images and it takes a relatively long time to display the retrieval result.

Thus, the display apparatus 1 according to an exemplary embodiment stores in the storage unit 40 at least one of preset image pattern information and matching information, and displays a primary retrieval result based on the stored image pattern information and matching information, and displays a secondary retrieval result of the entire images of the image database. Therefore, a user may obtain the overall image retrieval result quicker.

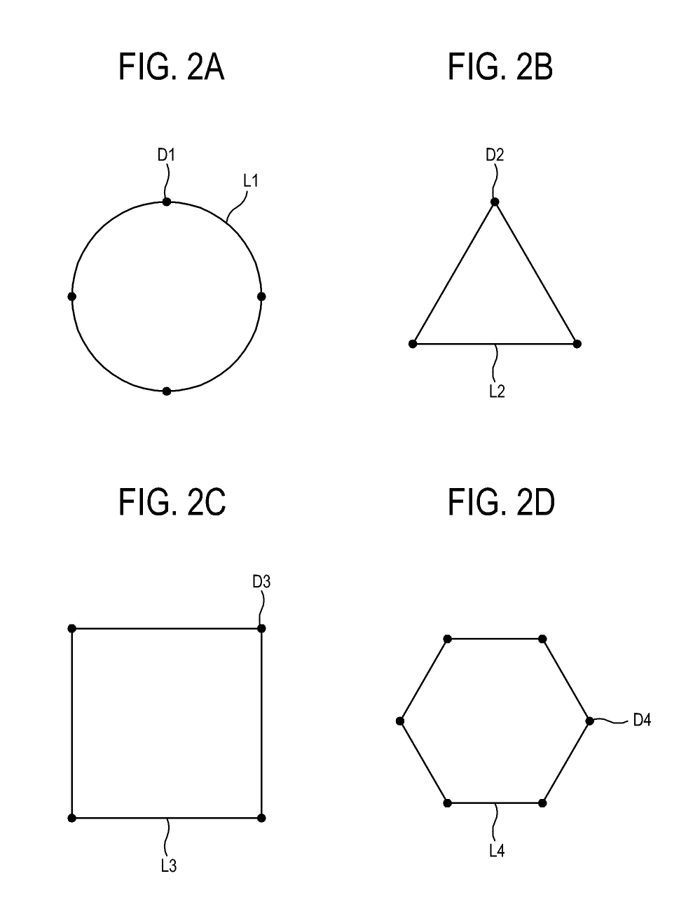

Hereinafter, the exemplary image pattern information and the exemplary matching information which are stored in the storage unit 40 will be described with reference to FIG. 2.

FIGS. 2A-2D are views illustrating an example of several image pattern information which are used for the image retrieval according to an exemplary embodiment.

The image pattern information means another type of an image that is generated by extracting and simplifying a characteristic of a predetermined image. For example, as shown in FIGS. 2A-2D, there can be circular image pattern information depicted in FIG. 2A, triangular image pattern information depicted in FIG. 2B, rectangular image pattern information depicted in FIG. 2C or hexagonal image pattern information depicted in FIG. 2D. FIGS. 2A-2D are provided by way of an example only, but the pattern of the pattern information is not limited thereto. Alternatively, there can be various types of pattern information including other type of diagrams i.e., open diagrams.

For example, the circular pattern information is formed by four dots D1 and a curved line L1 connecting the four dots. The triangular pattern information is formed by dots D2 of three vertexes and a straight line L2 connecting the dots D2. The rectangular pattern information is formed by dots D3 of four vertexes and a straight line L3 connecting the dots D3. The hexagonal pattern information is formed by dots D4 of six vertexes and a straight line L4 connecting the dots D4.

As discussed above, image pattern information varies depending on the number and pattern of dots and lines forming a two-dimensional diagram, arrangements of dots and lines, and the connection thereof.

In comparing the image pattern information to the image registered in the image database, the contents of the entire images in the image database may be scanned and retrieved to select an image matching the pattern information. The method of scanning the contents of entire images of the image database and retrieving the image matching the pattern information may vary and includes methods known to one of ordinary skill in the art. Thus, description of such method will be omitted.

For example, the image may be scanned to derive information of changes in color, saturation and brightness of entire images based on color, saturation and brightness information by pixel, to compare the derived result and the image pattern information through various mathematical algorithms and to determine that the similar image pattern information matches the image.

The matching information is information related to which image matches predetermined image pattern information among images registered in the image database. A single image may be similar to a plurality of pattern information, and there may be a plurality of pattern information matching a single image since pattern image information are similar to each other.

At an initial state, the storage unit 40 stores therein at least one of preset image pattern information and matching information for each of such image pattern information. Such information may be input additionally by a user or may be stored in the storage unit 40 when the display apparatus 1 is manufactured. The pattern and type of the image pattern information which is stored in the storage unit 40 may vary, and are described by way of an example and are non-limiting.

The exemplary method of inputting a predetermined pattern and retrieving an image by a user under the condition that the storage unit 40 stores therein the image pattern information and the matching information will be described as follows.

If a user inputs a predetermined first pattern, e.g., a hexagon, through the user input unit 60, information of the first pattern is received by the pattern receiver 50 and transmitted to the image processor 20.

The image processor 20 selects pattern information relating to the input first pattern among the image pattern information stored in the storage unit 40.

The relevance or similarity between the first pattern and the preset image pattern information may be designated in various ways. For example, if the first pattern is a hexagon, the pattern information relating to the first pattern may be selected by a following exemplary method in case the image pattern information stored in the storage unit 40 includes six patterns of a circle, a triangle, a rectangle, a diamond, a pentagon and a pentagram.

The hexagon as the first pattern is formed by six dots forming vertexes and six lines connecting the dots. As the first pattern is in a shape connecting two lines with respect to a single dot i.e. closed diagram which is a shape in which lines are connected with respect to each other, the image processor 20 may determine that circular, triangular, rectangular, diamond and pentagonal pattern information having the above characteristic in common and as such relate to the first pattern. However, this is only one exemplary embodiment, and the method of determining the relevance may be decided by various other mathematical algorithms.

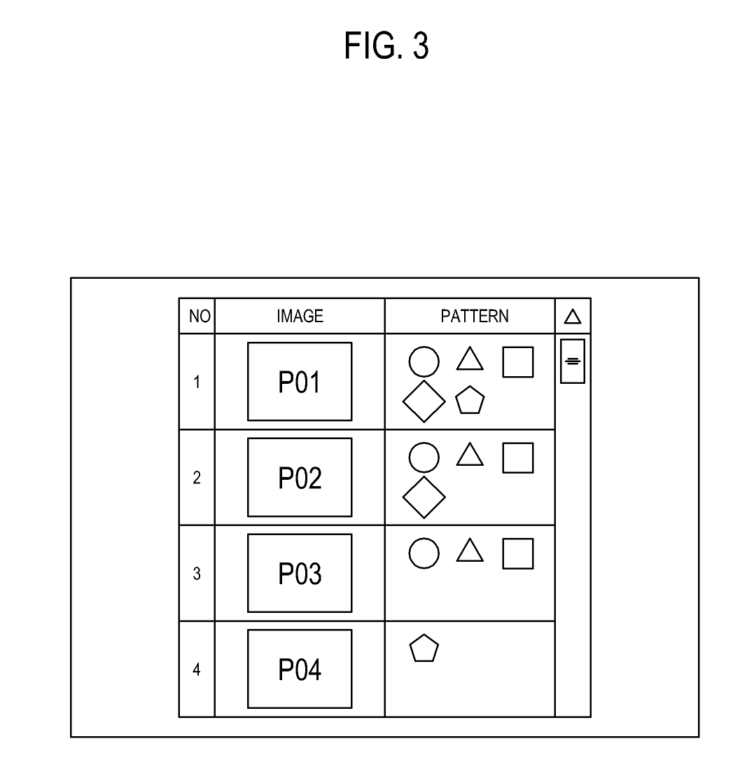

If the pattern information relating to the first pattern is selected from the image pattern information stored in the storage unit 40, the image processor 20 performs a primary retrieval that selects from the image database the image matching the selected pattern information based on the matching information stored in the storage unit 40. As shown in FIG. 3, the image processor 20 displays on the display unit 30 a primary retrieval result.

FIG. 3 is a view illustrating an example of the primary retrieval result displayed on the display unit 30 according to an exemplary embodiment.

The image processor 20 selects the image based on the image pattern information and matching information stored in the storage unit 40 instead of retrieving the contents of the images from the image database. Such primary retrieval does not include scanning of the entire images registered to the image database and derives the result relatively quickly.

If the pattern information relating to the first pattern as the hexagon is determined to be five patterns of a circle, a triangle, a rectangle, a diamond and a pentagon, the image processor 20 retrieves and selects the image matching the five pattern information.

As shown in FIG. 3, the image processor 20 displays on the display unit 30 images P01, P02, P03 and P04 selected according to the retrieval result. The image processor 20 displays on the display unit 30 the image pattern information together with the images P01, P02, P03 and P04, thereby enabling a user to confirm which pattern information matches the displayed images.

The order of displaying the images may vary. For example, if the pattern information that is selected at the time of the primary retrieval is plural, the images having a larger number of matching pattern information may be sequentially displayed.

While the primary retrieval result is being displayed, the image processor 20 performs a secondary retrieval that retrieves the contents of the entire images registered in the image database, and selects the image matching the first pattern. The image processor 20 may perform such secondary retrieval together with the primary retrieval or may perform the secondary retrieval after the primary retrieval. In any case, however, the first retrieval result is derived prior to the secondary retrieval result.

During the primary retrieval, the image processor 20 selects the pattern information relating to the first pattern from the preset image pattern information, and selects the image matching the selected pattern information based on the matching information. Meanwhile, during the secondary retrieval, the image processor 20 directly scans the contents of the images of the image database and retrieves the image matching the first pattern.

The secondary retrieval includes scanning of entire images and thus may produce a more accurate retrieval result than the primary retrieval, but takes a relatively long time. However, as the primary retrieval result is displayed prior to the secondary retrieval result, a user may obtain the broad retrieval result relatively quickly.

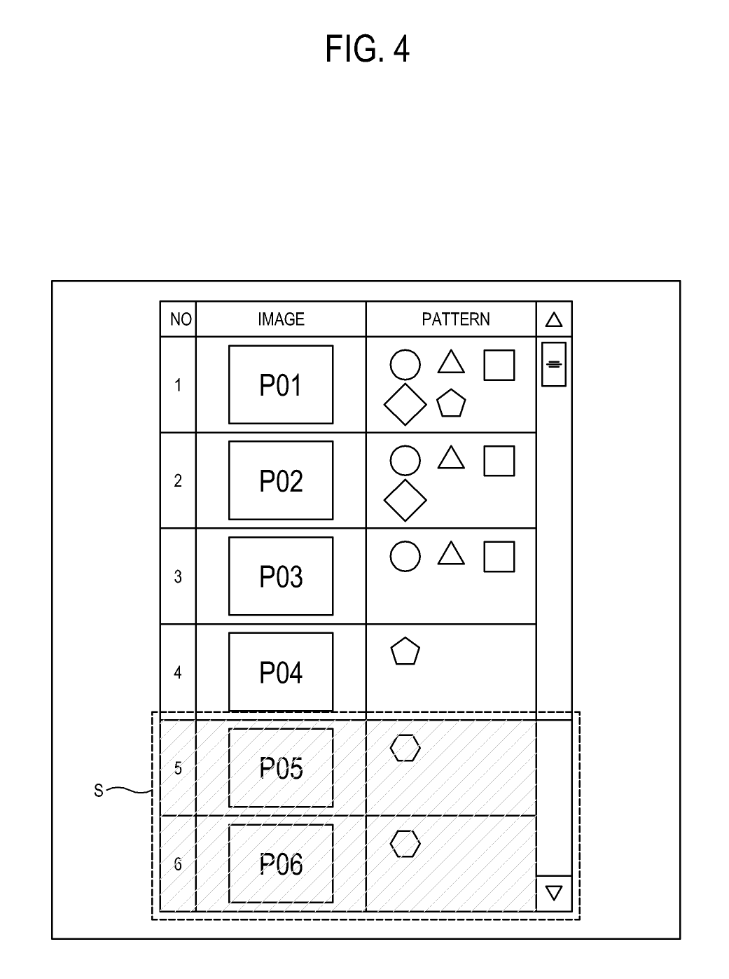

If the secondary retrieval result is derived, the image processor 20 displays the secondary retrieval result in addition to the primary retrieval result displayed on the display unit 30 as shown for example in FIG. 4. If images matching the first pattern as the hexagon include P05 and P06, the image processor 20 additionally displays the images P05 and P06 shown as selected S, and the first pattern matching the images P05 and P06 below the primary retrieval result.

According to another exemplary embodiment, the image processor 20 may replace the primary retrieval result displayed on the display unit 30 with the secondary retrieval result or display the secondary retrieval result above the primary retrieval result or display a popup window displaying the secondary retrieval result on top of the primary retrieval result.

If the secondary retrieval result is completed, the image processor 20 updates the image pattern information of the storage unit 40 with the first pattern as new pattern information, and updates the matching information of the storage unit 40 with the information of the image matching the first pattern derived from the secondary retrieval result.

As a user inputs various patterns for the retrieval, the image pattern information and matching information stored in the storage unit 40 increases. According to the increased quantity of the image pattern information and matching information, the image retrieval result at the time of the primary retrieval becomes more accurate, and a user may obtain a more accurate and prompt retrieval result.

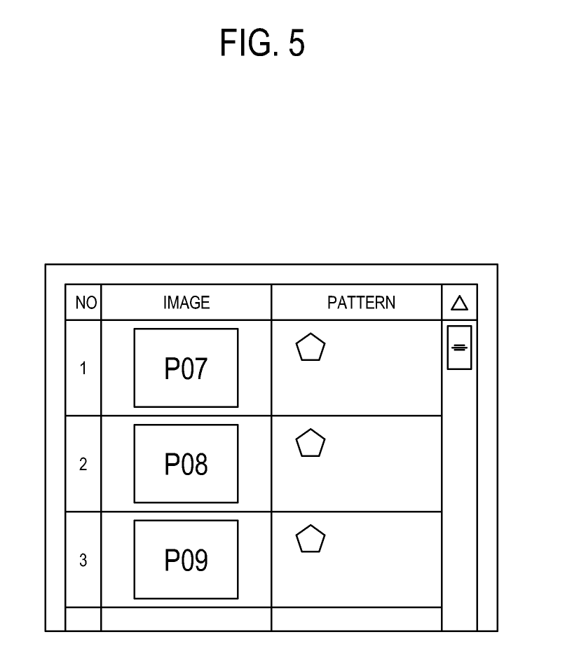

In relation to the foregoing, if it is determined that a predetermined first pattern received by the pattern receiver 50 is substantially the same as one of the image pattern information stored in the storage unit 40, the image processor 20 selects the image based on the matching information and displays the image as shown for example in FIG. 5.

As shown in FIG. 5, if it is determined that the input first pattern is one of the preset image pattern information, the image processor 20 selects matching images P07, P08 and P09 based on the pattern information and displays the images P07, P08 and P09 on the display unit 30.

As the pattern information and the matching information are already stored in the storage unit 40, retrieving the entire images of the image database is unnecessary. Accordingly, the image processor 20 does not retrieve the entire images of the image database, i.e., omits the secondary retrieval as in the prior exemplary embodiment.

According to an exemplary embodiment, at least one of the pattern information for the image retrieval from the image database and the matching information of the image matching the pattern information are preset. The image processor 20 performs the primary retrieval that selects and displays the image matching the pattern information relating to the input pattern based on the matching information, and performs the secondary retrieval that selects and displays the image matching the input pattern by retrieving the contents of the entire images of the image database. The image processor 20 updates the pattern information and the matching information with the input pattern and the secondary retrieval result.

Prior to the secondary retrieval result which is more accurate but takes a longer time, the primary retrieval result which is less accurate but takes a shorter time is displayed, and the retrieval result of the image matching the input pattern may be obtained more promptly and the retrieval may be utilized further.

Also, as the image and the pattern information matching the image are displayed together, a user may be provided with the pattern information relating to the image and thus may retrieve the image more easily in the future.

As the input pattern and the matching information of the image are updated, the primary retrieval result may be more accurate according to the increased number of image retrievals. Also, the retrieval result may be derived quicker.

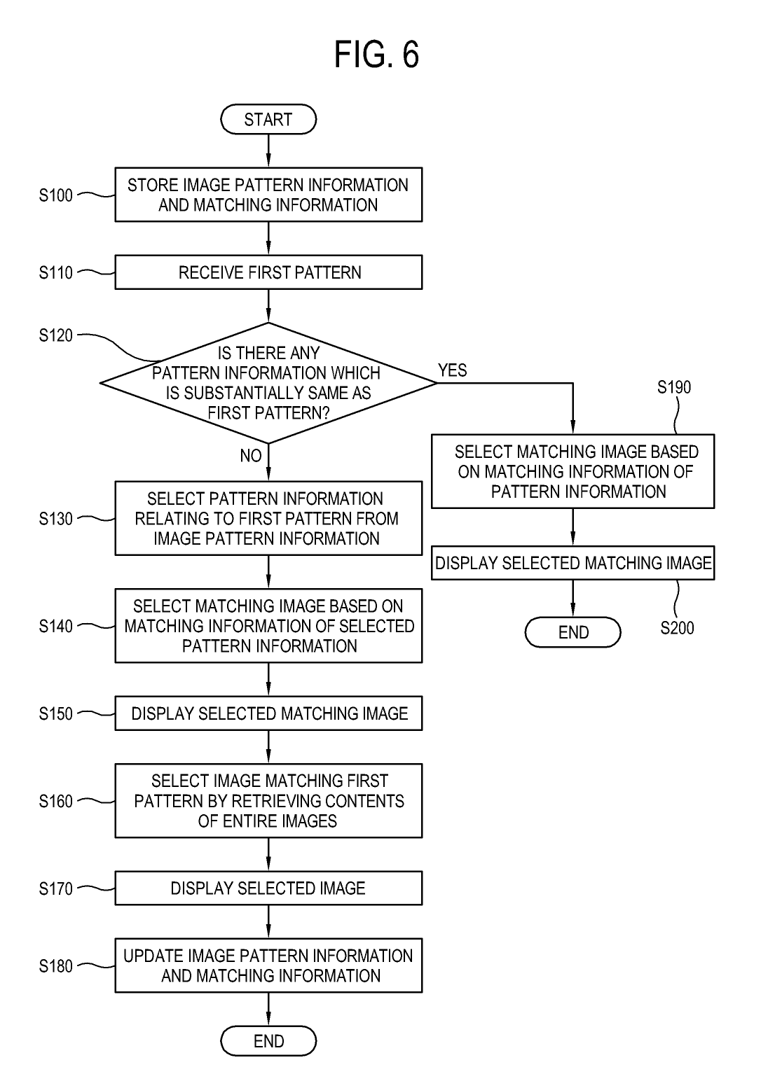

Hereinafter, a method of inputting the predetermined pattern and retrieving the image in the display apparatus 1 according to an exemplary embodiment will be described with reference to FIG. 6. FIG. 6 is a control flowchart of the above exemplary method.

At least one of the preset image pattern information and the matching information of the images stored in the image database are stored in the display apparatus 1 (S100).

Upon receiving predetermined information of a first pattern from the outside (S110), the image processor 20 determines whether the pattern information which is substantially the same as the first pattern exists among the prestored image pattern information (S120).

If it is determined that the pattern information which is substantially the same as the first pattern does not exist, the image processor 20 selects the pattern information which is determined to relate to the first pattern from the image pattern information (S130). The image processor 20 selects the matching image based on the matching information of the selected pattern information (S140), and primarily displays the selected matching image (S150).

The image processor 20 selects the image matching the first pattern by retrieving the contents of the entire images of the image database (S160), and secondarily displays the selected image (S170).

The image processor 20 updates the preset image pattern information and the matching information with the first pattern and the matching result of the image (S180).

At operation S120, if it is determined that the pattern information which is substantially the same as the first pattern exists, the image processor 20 selects the matching image based on the matching information relating to the pattern information (S190). The image processor 20 displays the selected image (S200).

According to the foregoing exemplary embodiment, the primary retrieval from operations S130 through S150 is performed prior to the secondary retrieval from operations S160 through S180. However, this is provided by way of an example only but not by way of a limitation, and the primary and secondary retrievals may be performed in parallel after the operation S120.

According to an exemplary embodiment, the image database is stored in the storage unit 40, but the storage location is not limited thereto.

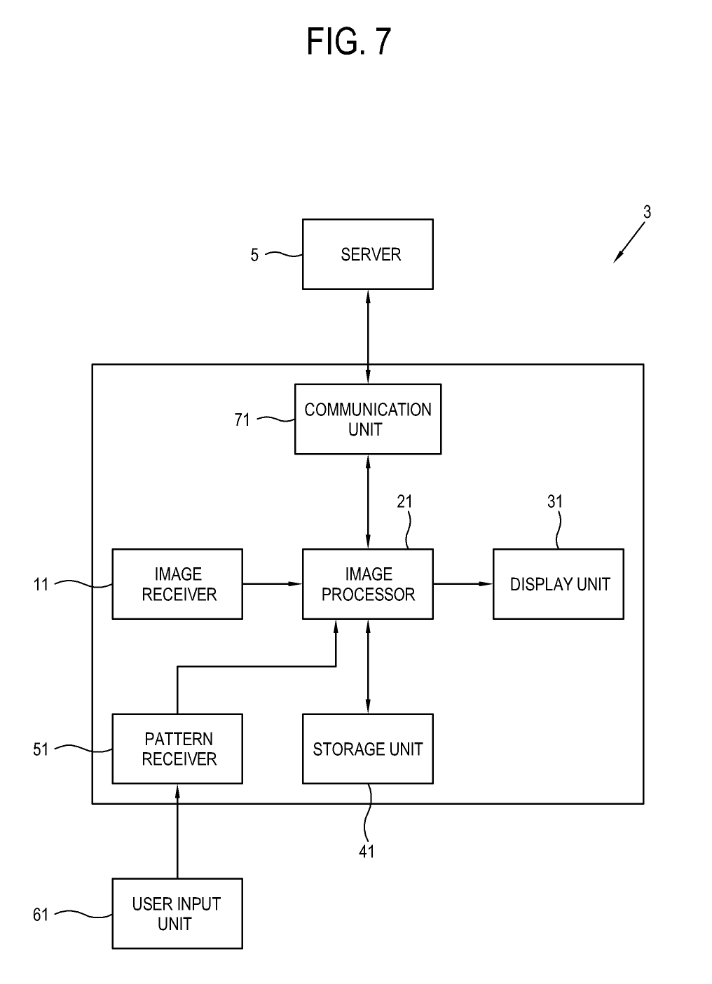

FIG. 7 is a block diagram illustrating a display apparatus according to another exemplary embodiment.

As shown therein, the display apparatus 3 according to an exemplary embodiment includes an image receiver 11, an image processor 21, a display unit 31, a storage unit 41, and a pattern receiver 51. The functions of the foregoing elements which are analogous as those according to an exemplary embodiment described above and are not repeated herein.

The display apparatus 3 further includes a communication unit 71 which communicates with an external server 5. Unlike in an exemplary embodiment described above, the server 5 stores therein an image database and the storage unit 41 stores therein image pattern information and matching information excluding the image database.

Upon receiving predetermined pattern information from the user input unit 61, the image processor 21 accesses the image database stored in the server 5 through the communication unit 71 and retrieves an image. Such image retrieval is analogous as that according to an exemplary embodiment described above, and thus the detailed description thereof will be omitted.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display unit;
a pattern receiver which receives from an outside a first pattern; and
an image processor which performs:
a primary retrieval that selects pattern information relating to the first pattern from preset image pattern information which is patterning contents of a plurality of images to retrieve the images and selects a first image matching the selected pattern information based on matching information, and
a secondary retrieval that selects a second image matching the first pattern by retrieving the contents of the images.

2. The display apparatus according to claim 1, wherein the image processor updates the preset image pattern information with the first pattern, and updates the matching information with a secondary retrieval result.

3. The display apparatus according to claim 1, wherein the display unit displays at least one of the image pattern information matching the displayed first image, together with the second image.

4. The display apparatus according to claim 1, wherein the image processor causes the display unit to sequentially display the first image according to a number of the pattern information matching the first pattern if the pattern information selected from the preset image pattern information is plural.

5. The display apparatus according to claim 1, wherein the image processor selects and causes the display unit to display the first image based on the matching information and omits a retrieval of entire images if it is determined that the first pattern is substantially the same as one of the preset image pattern information.

6. The display apparatus according to claim 1, further comprising a user input unit which receives input of the first pattern and transmits the input first pattern to the pattern receiver.

7. The display apparatus according to claim 6, wherein the user input unit comprises at least one of a touch pad, a touch screen, and a tablet.

8. The display apparatus according to claim 1, wherein the preset image pattern information comprises a two-dimensional diagram formed by at least one dot and at least one line.

9. The display apparatus according to claim 1, wherein the plurality of images is stored in a storage unit or is stored in a server that is connected to the display apparatus by a local connection or a network.

10. A method of controlling a display apparatus, the method comprising:
receiving a first pattern which is input from an outside;
selecting pattern information related to the first pattern from preset image pattern information which is patterning contents of a plurality of images to retrieve the images;
selecting and displaying a first image matching the selected pattern information based on matching information; and
selecting and displaying a second image matching the first pattern by retrieving the contents of the images.

11. The method according to claim 10, wherein the displaying the second image comprises updating the preset image pattern information with the first pattern, and updating the matching information with a retrieval result of the second image.

12. The control method according to claim 10, wherein the displaying the first image and displaying the second image comprise displaying the at least one of the image pattern information matching the first image, together with the second image.

13. The control method according to claim 10, wherein the displaying the first image comprises sequentially displaying the images according to a number of the pattern information matching the first image if the pattern information selected from the preset image pattern information is plural.

14. The control method according to claim 10, further comprising selecting and displaying the first image based on the matching information and omitting a retrieval of the plurality of images if it is determined that the first pattern is substantially the same as one of the preset image pattern information.

15. The display apparatus according to claim 1, further comprising:
a storage unit which stores therein the preset image pattern information of patterning contents of the plurality of images and the matching information related to the images matching each of the pattern information.

16. The display apparatus according to claim 1, wherein the matching information comprises rules for matching pattern information to the first pattern.

17. The method of claim 10, further comprising storing the preset image pattern information of patterning contents of the plurality of images and the matching information related to the images matching each of the pattern information.

18. The method of claim 10, wherein the matching information comprises rules for matching pattern information to the first pattern.

19. A method of controlling a display apparatus, the method comprising:
receiving a first pattern;
selecting at least one second pattern that relates to the first pattern from a plurality of second patterns that pattern contents of a plurality of images;
selecting at least one first image that matches the at least one selected second pattern based on matching rules for matching the images to the respective at least one second pattern; and
selecting at least one second image by directly comparing the plurality of images with the first pattern.

20. The method according to claim 19, further comprising displaying the selected at least one first image together with the selected at least one second image.
